(19) United States
(12) Patent Application Publication
(10) Pub. No.: US 2025/0043375 A1
(43) Pub. Date: Feb. 6, 2025

(54) NI-FREE MICRO-ALLOYED HIGH-STRENGTH STEEL WITH ULTRA-LOW TEMPERATURE TOUGHNESS, AND PREPARATION METHOD THEREOF

(71) Applicants: WUHAN UNIVERSITY OF SCIENCE AND TECHNOLOGY, Wuhan (CN); WUKE XINCAI (WUHAN) TECHNOLOGY CO., LTD., Wuhan (CN); WUKE COMPOSITE MATERIALS (HAIKOU) TECHNOLOGY CO., LTD., Haikou (CN); SINO-ENERGY HUAYUAN FLOATING WIND INSTITUTE, Qingdao (CN)

(72) Inventors: Kaiming WU, Wuhan (CN); Shaoguan XIANG, Wuhan (CN)

(73) Assignees: WUHAN UNIVERSITY OF SCIENCE AND TECHNOLOGY, Wuhan (CN); WUKE XINCAI (WUHAN) TECHNOLOGY CO., LTD., Wuhan (CN); WUKE COMPOSITE MATERIALS (HAIKOU) TECHNOLOGY CO., LTD., Haikou (CN); SINO-ENERGY HUAYUAN FLOATING WIND INSTITUTE, Qingdao (CN)

(21) Appl. No.: 18/436,033

(22) Filed: Feb. 8, 2024

(30) Foreign Application Priority Data
Aug. 3, 2023 (CN) 2023109799625

(51) Int. Cl. C21D 9/00; C21C 7/06; C21C 7/10; C21D 1/18; C21D 6/00; C21D 8/02; C22C 38/00; C22C 38/02; C22C 38/04; C22C 38/12; C22C 38/14

(52) U.S. Cl. CPC C21D 9/0081; C21C 7/06; C21C 7/10; C21D 1/18; C21D 6/005; C21D 6/008; C21D 8/0205; C21D 8/021; C21D 8/0226; C21D 8/0247; C22C 38/001; C22C 38/002; C22C 38/005; C22C 38/02; C22C 38/04; C22C 38/12; C22C 38/14

(57) ABSTRACT

A Ni-free micro-alloyed high-strength steel with ultra-low temperature toughness and a preparation method thereof are provided. The micro-alloyed high-strength steel includes the following chemical components by mass percentage: 0.011% to 0.099% of C, 0.051% to 0.24% of Si, 1.21% to 1.49% of Mn, 0.030% to 0.059% of Nb, 0.009% to 0.016% of Ti, 0.001% to 0.018% of Zr, 0.001% to 0.018% of rare earth (RE), and the balance of Fe and inevitable impurities. The mass percentage also meet the following formulas: 0.21%<C+Si<0.24%, and Si/C=1 to 8; 0.02%<Nb+Ti<0.05%, and Nb/Ti=1 to 3; 0.010%<Zr+RE<0.019%, and Zr/RE=1 to 6. The micro-alloyed high-strength steel uses a completely different composition design (i.e., a simple low-cost Ni-free composition design) to realize ultra-low temperature toughness, and with the help of Zr+RE compound deoxidation and Nb+Ti compound micro-alloying technologies, realizes ultra-low temperature toughness at −100° C. to −120° C.

### CROSS REFERENCE TO THE RELATED APPLICATIONS

This application is based upon and claims priority to Chinese Patent Application No. 202310979962.5, filed on Aug. 3, 2023, the entire contents of which are incorporated herein by reference.

### TECHNICAL FIELD

The present invention relates to the technical field of metal materials, and in particular to a Ni-free micro-alloyed high-strength steel with ultra-low temperature toughness, and a preparation method thereof.

### BACKGROUND

Cryogenic steel is an important variety of low-alloy high-strength steel. Usually, all kinds of production and storage vessels and conveying pipelines for liquefied petroleum gas, liquid ammonia, liquid oxygen and liquid nitrogen, and devices for service in cold regions, are called low-temperature vessels, and the steel for manufacturing these vessels is collectively referred to as low-temperature steel. In China, the design temperature lower than or equal to −20° C. is usually called low temperature (Appendix C Low-Temperature Pressure Vessels of GB 150-1998 Steel Pressure Vessels).

Low-temperature steel is generally classified as nickel-free steel and nickel steel. Nickel-free steel generally refers to fine-grained steel and low-temperature high-strength steel, and its service temperature is above −60° C. Nickel steel refers to steel added with an alloying element Ni, which is soluble in ferrite, so that the low-temperature toughness of a matrix is significantly improved to change the common phenomenon of low-temperature brittle transition of metal materials with body-centered cubic lattices, and its service temperature may reach below −196° C.

With the development of the petrochemical industry, new processes and devices have been emerging constantly. Liquefaction, separation, storage, transportation and application of gases have become widespread in all countries. The development of these low-temperature technologies and devices promotes the development of steel for low-temperature pressure vessels. According to the standards of Japan JIS G 3127 (1977) Nickel Steel Plate for Low-Temperature Pressure Vessels, the representative grades of steel are SL3N255, SL3N275, SL3N440, etc. According to the standards of American SA-203/SA-203M Nickel Alloy Steel Plate for Pressure Vessels, the representative grades are SA203Gr.D, SA203Gr.E and SA203GR.F. Low-temperature steel containing 3.5% to 9% of Ni has its corresponding standards in the United States. Japan and Europe. At the end of 1960s, China developed low-temperature steel from −40° C. to −253° C., but it was not popularized. In 1983, the Standardization Administration of the P.R.C issued GB3531-83 Technical Specifications for Low Alloy Steel Thick Plates for Low temperature Pressure Vessels, in which four kinds of nickel-free low-temperature steels with their service temperatures ranging from −30° C. to −90° C. are stipulated. 16MnDR steel is an economical and mature steel grade for manufacturing low-temperature devices at −40° C., which can be used for manufacturing devices, for example, a liquid ammonia device. 15MnNiDR and 09MnNiDR are nickel-based low-temperature steels with excellent low-temperature toughness and weldability. The −70° C. grade 09MnNiDR low-temperature steel has been widely applied to low-temperature apparatuses for ethylene, chemical fertilizer, city gas, carbon dioxide and the like, gradually replacing imported low-temperature steel for successful manufacture of ammonia separators (−28° C.), high-pressure nitrogen storage tanks (−28° C.), carbon dioxide low-temperature storage tanks (−50° C.) and low-temperature ethylene storage tanks (−60° C.).

As for the low-temperature steel with a higher content of Ni, the material section of CCS 1996 Rules for Building and Classing Steel Vessels in China stipulates that nickel alloy steel with a thickness not exceeding 50 mm is suitable for manufacturing liquid cargo tanks and hull structures near the liquid cargo tanks of liquefied gas carriers, including three grades of steel: 3.5 Ni, 5 Ni and 9 Ni (Table 1). In China, the use of 3.5 Ni low-temperature steel for manufacturing −100° C. grade low-temperature vessels and the use of 9 Ni low-temperature steel for manufacturing −196° C. low temperature vessels have reached a consensus in the industry of pressure vessels. 3.5 Ni steel is widely applied to low-temperature vessels from −101° C. to −80° C.

TABLE 1
Delivery Status and Mechanical Properties of Ni-based Low-temperature Steel in China

| | | | | | Charpy V-notch Impact Test Aₖᵥ/J | | | | |
|---|---|---|---|---|---|---|---|---|---|
| Grade | Delivery | | | | Temperature | Average value of 3 | | Minimum value of | |
| of Steel | Status | R_{eL}/Mpa≥ | Rₘ/Mpa≥ | A/%≥ | T (° C.) | samples≥ | | single sample≥ | |
| 0.5 NiA | N or QT | 285 | 400-530 | 24 | −60 | Longitudinal | Transverse | Longitudinal | Transverse |
| 0.5 NiB | | 355 | 490-610 | 22 | −60 | 41 | 27 | 27 | 18 |
| 1.5 Ni | N, NT or | 275 | 470-640 | 22 | −65 | | | | |
| 3.5 Ni | QT | 345 | 440-690 | 21 | −95 | | | | |
| 5 Ni | | 390 | 520-710 | 21 | −110 | | | | |
| 9 Ni | NNT or | 490 | 640-830 | 19 | −196 | | | | |
| | QT | | | | | | | | |

Nickel-based low-temperature steel in low-temperature steel is widely used in developed countries such as the United States and Japan because of its high strength, excellent low-temperature toughness and lower cost than Cr—Ni stainless steel of the corresponding temperature level. For low-temperature vessels, the lower the temperature of a stored medium is, the lower the pressure the vessel has to bear, and the higher its safety and reliability are. For liquefied natural gas. 9 Ni (−196° C.) low-temperature steel is mostly used at present; and low-temperature apparatuses in petrochemical and fertilizer industries need to liquefy gases at about −80° C., so that 3.5 Ni (−100° C.) low-temperature steel is usually used.

The above descriptions are mainly about the application of and requirements for low-temperature steel of low temperature pressure vessels and devices. Polar environments, extremely-cold environments and their requirements for low temperature are introduced from the perspectives of polar oil and gas development, polar ship transportation and polar ice-breaking devices. The polar natural conditions are harsh, and there are challenges such as low-temperature tests, sea ice obstruction, iceberg attacks, snowstorm attacks, fragile ecological environments, polar night disturbance, poor visibility, etc., which demand much on related devices and material performance. The ultra-low temperature environment in the Arctic puts forward the demand for low-temperature resistant steel materials. According to the 40-year tracking survey of nearly 700 polar ships by Lloyd's Register, 57% of polar ships have cracks or fractures in their hull steel structures after an average age of 13 years. Heavy icebreakers usually use special low-temperature steel, which must have sufficient comprehensive properties such as low-temperature toughness, strength and fatigue strength.

In recent years, polar ships have gradually developed from low-grade ice strengthened type to high-grade strengthened type with self-ice-breaking performance, and the demand for polar oil tankers, polar LNG ships, polar container ships, and other new commercial ice-breaking ships with ice-breaking capability has been growing rapidly. Accordingly, material research and development of polar ship steel plates, deck machinery and core components with cold resistance and high toughness must also be strengthened. The construction of polar ships and devices is in urgent need of developing low-temperature steel materials such as low-temperature high-strength steel for ships and high-strength steel for low-temperature vessels, and breaking through key technologies such as low-temperature resistance, excellent weldability and high toughness.

At present, for the above special requirements, first of all, the conventional technology of low-temperature steel usually improves the low-temperature toughness by adding the element Ni. This is mainly because: (1) Ni does not form a carbide with carbon, but is a main alloying element for forming and stabilizing austenite; (2) Ni is a pure soluble element in steel, which can strengthen a ferrite matrix and obviously reduce the ductile-brittle transition temperature; (3) a fine grain structure is acquired by means of controlled rolling; and (4) a stable structure is acquired by means of heat treatment. Secondly, carbide-forming elements, such as Nb, Ti and Mo, are added to the steel, and the comprehensive properties of the steel are improved by precipitation strengthening and grain refining functions produced thereby. Thirdly, the welding performance is improved by using Nb, Ti and V micro-alloying. In order to improve the corrosion resistance, it is sometimes necessary to add alloying elements such as Cr and Cu. The conventional technology described above results in a high-cost and expensive low-temperature steel.

However, the lowest temperature in polar regions and extremely-cold regions is −70° C. and below, so that steel plates used in polar regions and extremely-cold regions need to meet the impact toughness of a lower temperature in order to improve the safety reserve. Therefore, it is urgent to develop a high-strength steel plate with high strength, excellent low-temperature toughness and low cost. In view of this, the present invention provides a Ni-free micro-alloyed high-strength steel with ultra-low temperature toughness, and a preparation method thereof.

### SUMMARY

A technical problem to be solved by the present invention is to provide a Ni-free micro-alloyed high-strength steel with ultra-low temperature toughness, and a preparation method thereof. The objective is to solve the problems of high cost, insufficient weldability and a complicated manufacturing process of traditional low-temperature steel.

The present invention solves the above technical problems by, on the one hand, providing a Ni-free micro-alloyed high-strength steel with ultra-low temperature toughness, including the following chemical components by mass percentage: 0.011% to 0.099% of C, 0.051% to 0.24% of Si, 1.21% to 1.49% of Mn, 0.030% to 0.059% of Nb, 0.009% to 0.016% of Ti, 0.001% to 0.018% of Zr. 0.001% to 0.018% of rare earth (RE), and the balance of Fe and inevitable impurities;

The mass percentages of the elements C and Si also meet a formula: 0.21%<C+Si<0.24%, and Si/C=1 to 8;

The mass percentages of the elements Nb and Ti also meet a formula: 0.02%<Nb+Ti<0.05%, and Nb/Ti=1 to 3; and

The mass percentages of the elements Zr and RE also meet a formula: 0.010%<Zr+RE<0.019%, and Zr/RE=1 to 6.

All the elements in the Ni-free micro-alloyed high-strength steel with ultra-low temperature toughness, provided by the present invention, play the following roles.

Carbon: the content of the element C has a large influence on the mechanical properties, welding properties and corrosion properties of steel materials. In the case of the same temperature, as the content of C increases, the number of C atoms to be migrated for diffusion-controlled interface motion increases, and diffusive phase transformation, for example, ferrite and pearlitic phase transformation, is inhibited. An excessively high content of C makes it easy to form bainite and martensite phases during cooling. The bainite and martensite phases are hard and brittle, and their low-temperature impact properties are relatively poor. In the present invention, C is added appropriately, and polygonal ferrite and fine and dispersed pearlite are acquired by means of appropriate diffusive phase transformation, without forming the bainite and martensite phases during cooling. Therefore, the mass percentage of carbon in the micro-alloyed high-strength steel according to the present invention is 0.011%<C<0.099%.

Silicon: Si does not form a carbide with C, but exists in steel in the form of a solid solution, and by interacting with the stress field of a mobile dislocation, it hinders dislocation movement, thereby improving the strength of steel and iron materials. The higher content of Si is unfavorable to the weldability of the steel and iron materials. In addition, the higher content of Si also reduces the ductility and toughness of steel. Therefore, the mass percentage of silicon in the micro-alloyed high-strength steel according to the present invention is 0.051%<Si<0.24%.

Manganese: Mn is an austenite-forming element and enlarges the austenite phase area. In the process of cooling, Mn dissipates free energy by means of a solvent drag effect, and inhibits diffusive phase transformation. By adding an appropriate amount of Mn, the microstructure of a steel plate can be controlled under appropriate technological conditions, and a fine bainite lath structure with high strength and toughness can be formed. An excessively high content of Mn may lead to cracks in a slab during continuous casting and subsequent cooling. Mn can also achieve deoxidization and eliminate the effects of S in the process of smelting, and Mn in steel is combined with S to form MnS, which can prevent thermal brittleness caused by S. Generally speaking, an appropriate amount of Mn is added into low-alloy high-strength steel to improve the strength of the steel. Therefore, the mass percentage of Mn in the micro-alloyed high-strength steel according to the present invention is 1.21% to 1.49%.

Phosphorus: phosphorus has a strong solution strengthening effect in steel, and can improve the strength and the atmospheric corrosion resistance of the steel when added as an alloying element into low-alloy structural steel. However, phosphorus has the most harmful effect of serious segregation, also increases temper brittleness, and significantly impairs the plasticity and toughness of steel. Phosphorus also has an adverse effect on weldability. Thus, phosphorus is a harmful element and should be strictly controlled. Therefore, the mass percentage of phosphorus in the micro-alloyed high-strength steel according to the present invention is P≤0.0049%.

Sulfur: Sulfur is subject to serious segregation in steel, which deteriorates the internal and surface quality of steel; and sulfur also reduces the plasticity of steel, thus is a harmful element, and exists in the form of FeS with a low melting point. The melting point of FeS alone is only 1.190° C., but the eutectic temperature of eutectic formed by FeS with iron in steel is even lower, and is only 988° C. As steel solidifies, iron sulfide precipitates at a primary grain boundary. When steel is rolled at 1,100° C. to 1,200° C., FeS on the grain boundary will melt, which greatly weakens a bonding force between grains and leads to hot brittleness of steel. Therefore, sulfur should be strictly controlled, and the mass percentage of sulfur in the micro-alloyed high-strength steel according to the present invention is S≤0.0010%.

Nb: In case of a low content of carbon, an appropriate content of Nb can refine ferrite grains and improve the strength and the low-temperature toughness of steel. In case of a high content of Nb, the precipitation of proeutectoid ferrite will be delayed, and the time when austenite begins to decompose into pearlite will be extremely delayed, which causes almost no effect on transformation from austenite to bainite. In this case, bainite will appear in a steel plate, but the impact toughness of the steel plate will be deteriorated. Therefore, the mass percentage of niobium in the micro-alloyed high-strength steel according to the present invention is 0.031% to 0.059%.

Titanium: Titanium has strong affinity with oxygen, nitrogen and carbon, and is a good deoxidizer and an effective element for fixing nitrogen and carbon. TiN particles can effectively prevent austenite grains from coarsening in the process of a welding thermal cycle, which is beneficial to the improvement of toughness, and the TiN particles can effectively promote the formation of acicular ferrite, effectively improving the welding performance of steel. However, an excessive content of Ti is not conducive to improvement of the properties of steel, and is prone to the formation of a coarse carbonitride of titanium as a source of cracks, resulting in decrease of toughness. Therefore, the mass content of Ti in the present invention is 0.009% to 0.016%.

Zirconium: Zirconium is a strong carbide-forming element, and is also a strong deoxidizing element and a composite oxysulfide-forming element. Adding a small amount of zirconium can achieve the functions of degassing, purification and grain refining, which is beneficial to improve the low-temperature performance and the stamping performance of the low-alloy high-strength steel. The hardenability of steel can be significantly improved when zirconium is dissolved in austenite. Therefore, the mass percentage of zirconium in the micro-alloyed high-strength steel according to the present invention is 0.001% to 0.018%.

Rare earth: The element RE mainly plays the following roles in steel. (1) The purity of molten steel is improved, and harmful elements are removed from steel, i.e., strong deoxidation and desulfurization are achieved. By adding the element RE, the contents of oxygen and sulfur in the molten steel can be reduced to very low levels. Therefore, rare earth needs to be subjected to other deoxidization treatments before entering the molten steel as a deoxidizer, so that its utilization rate is increased. (2) The element of RE can serve as a modifier for inclusions. In comparison with traditional Al deoxidation inclusions, the added rare earth can react with the element Al in the molten steel and generate REAlO₃, and the added rare earth can refine and spheroidize the inclusions. (3) A micro-alloying function can be achieved. It is believed that the added rare earth can reduce temper embrittlement of steel. Phosphorus, sulfur and other elements in steel are easily segregated toward the primary austenite grain boundary, resulting in a temperature rise of the steel and iron material from toughness to brittleness. The added rare earth element can be combined with oxygen, sulfur, phosphorus and other elements distributed on the grain boundary to form inclusions, so as to eliminate or reduce the impact of such elements on temper embrittlement of the steel and iron material. When the addition of rare earth exceeds a critical content, rare earth will segregate at the grain boundary and destroy the orientation relationship of pearlites, leading to an increase of lamellar spacing and a decrease of impact toughness of the pearlites. Therefore, the mass percentage of rare earth in the micro-alloyed high-strength steel according to the present invention is 0.001% to 0.018%.

It should be noted that in the above formula Si/C=1 to 8, Si and C respectively represent their respective mass percentages, and values substituted into the above formula are values before the percent signs. For example, if the mass percentage of Si is 0.17% and the mass percentage of C is 0.05%, the above formula is Si/C=0.17/0.06=2.83. In addition, the formulas of Nb/Ti=1 to 3 and Zr/RE=1 to 6 are the same as Si/C=1 to 8.

The present invention has the following beneficial effects:
(1) the micro-alloyed high-strength steel according to the present invention uses a composition design (i.e., a simple low-cost Ni-free composition design) completely different from that in the prior art to realize ultra-low temperature toughness, and with the help of Zr+RE compound deoxidation and Nb+Ti compound micro-alloying technologies, realizes ultra-low temperature toughness at −100° C. to −120° C.;
(2) the micro-alloyed high-strength steel plate according to the present invention uses a cheap chemical composition design of low carbon, low silicon and medium manganese, and is completely free from precious metal elements such as Cr, Ni and Cu, thus greatly reducing the material cost;
(3) instead of the traditional Al deoxidation technology, the present invention uses Si—Mn deoxidation supplemented with Zr—Ti-RE compound deoxidation to form a fine, dispersed and uniform composite oxysulfide, which significantly improves the plasticity and toughness; and
(4) by means a low-carbon equivalent design, a micro-alloyed high-strength steel plate according to the present invention has excellent welding performance (CEV≤0.39, Ceq≤0.17); and by using Nb, Ti. Zr and RE compound micro-alloying, together with rolling parameter control in the TMCP, the steel plate has fine grains, and high strength and toughness. The Ni-free micro-alloyed high-strength low-temperature steel is particularly suitable for structural materials of polar regions, vessels, pipelines, refining, storage and transportation, devices and the like used in low-temperature and ultra-low temperature (−20 to −120° C.) environments. In addition to its excellent low-temperature toughness and its superiority, this material also has significant characteristics such as high strength and excellent weldability.

Based on the technical solutions described above, the present invention may also be improved as follows.

Further, the Ni-free micro-alloyed high-strength steel with ultra-low temperature toughness includes the following chemical components by mass percentage: 0.03% to 0.09% of C. 0.13% to 0.20% of Si, 1.4% to 1.48% of Mn, 0.035% to 0.055% of Nb, 0.009% to 0.016% of Ti, 0.010% to 0.015% of Zr, 0.002% to 0.004% of RE, and the balance of Fe and inevitable impurities are provided.

Further, the Ni-free micro-alloyed high-strength steel with ultra-low temperature toughness includes the following chemical components by mass percentage: 0.05% of C, 0.17% of Si, 1.4% of Mn, 0.03% of Nb, 0.015% of Ti, 0.008% of Zr, 0.007% of RE, and the balance of Fe and inevitable impurities are provided.

Further, in the inevitable impurities, the mass percentages of the elements P, S, O, N and H respectively meet: P≤0.0049%, S≤0.0010%, O≤0.0049%, N≤0.0039% and H≤0.00019.

Further, the element RE includes lanthanum and cerium, and the weight ratio of the elements lanthanum to cerium is (70-90):(10-30).

Further, a microstructure type of the micro-alloyed high-strength steel is free from a ferrite-pearlite banded structure, and the effective grain size of the microstructure of the micro-alloyed high-strength steel is less than or equal to 5 μm.

Further, the micro-alloyed high-strength steel has V-notch impact absorbing energy of greater than 300 J at −120° C.

Further, the micro-alloyed high-strength steel has a ductile-brittle transition temperature of −110° C. to −130° C.

In a second aspect of the present invention, a preparation method of a Ni-free micro-alloyed high-strength steel with ultra-low temperature toughness is provided, including the following steps:
1) smelting and refining molten steel sequentially, then performing vacuum treatment, and then, continuously casting to obtain a slab;
2) heating and soaking the slab to obtain a heat-treated slab; and
3) continuously rolling the heat-treated slab, controlling a final rolling temperature to be 750° C. 850° C., cooling with water to 410° C. to 550° C. after rolling, and naturally cooling to a room temperature to obtain the micro-alloyed high-strength steel.

Further, the specific smelting and refining method in step 1) is as follows: performing steel-making on molten iron and/or scrap steel by using a converting furnace (BOF) or an electric arc furnace (EAF), then adjusting temperature and composition to obtain molten steel, adjusting a tapping temperature of the molten steel to 1,549° C. to 1,689° C., wherein the molten steel contains free oxygen of 99 ppm to 398 ppm; enabling the molten steel to enter a ladle, and pre-deoxidizing the molten steel in the ladle by using Fe—Si alloy or Fe—Si—Mn alloy under fine argon bubbling to adjust the content of free oxygen in the molten steel to 10 ppm to 98 ppm; and performing final deoxidation using a composite additive under fine argon bubbling, and performing LF refining, VD refining or RH refining on the molten steel subjected to final deoxidation.

The composite additive described above is added into the molten steel in the form of block alloy or a cored wire, and the particle size of the composite additive is 4 mm to 20 mm. The addition of the composite additive is 0.49 kg to 4.8 kg per ton of the molten steel. Then, LF refining, VD refining or RH refining is performed on the refined molten steel according to a conventional process. Finally, the refined molten steel is continuously cast according to a conventional process. The composite additive is a composition of zirconium, titanium and rare earth, and the weight ratio of the elements zirconium to titanium to rare earth in the composite additive is 7:20:6, in which the rare earth includes lanthanum and cerium, and the weight ratio of lanthanum to cerium is 80:20.

### BRIEF DESCRIPTION OF THE DRAWINGS

FIG. 1 is a low-temperature ductile-brittle transition temperature (DBTT) curve of micro-alloyed high-strength steel according to the present invention;

FIG. 2 is an oscillometric impact curve of the micro-alloyed high-strength steel according to the present invention and contrast steel;

FIG. 3 is an Ashby diagram of Charpy impact energy at −100° C. to yield strength at room temperature of the micro-alloyed high-strength steel according to the present invention and the contrast steel;

FIGS. 4A-4B are the front morphology of a low-temperature Charpy impact fracture of the micro-alloyed high-strength steel according to the present invention, where FIG. 4A shows the temperature of −100° C. and FIG. 4B shows the temperature of −120° C.; and

FIG. 5A is a Charpy impact fracture at −100° C. of the micro-alloyed high-strength steel according to the present invention.

FIG. 5B is a micro-morphology of part 1 in FIG. 5A.

FIG. 5C is a micro-morphology of part 2 in FIG. 5A.

FIG. 5D is a micro-morphology of part 3 in FIG. 5A.

### DETAILED DESCRIPTION OF THE EMBODIMENTS

The principles and features of the present invention are described below, and the examples given are for the purpose of explaining the present invention only and are not intended to limit the scope of the present invention. The embodiments in which specific techniques or conditions are not indicated should be in accordance with the techniques or conditions described in the literature in the art, or in accordance with the product specifications. Reagents or instruments used on which manufacturers are not indicated are all conventional products commercially available through regular channels.

The following composite additive is a composition of zirconium, titanium and rare earth, and the weight ratio of the elements zirconium to titanium to rare earth in the composite additive is 7:20:6, in which rare earth includes lanthanum and cerium, and the weight ratio of lanthanum to cerium is 80:20. Contrast steel is bulky and clustered alumina and its composite oxides formed by final deoxidation of conventional aluminum blocks, aluminum particles or aluminum wires.

### Embodiment 1

This embodiment relates to a Ni-free micro-alloy high-strength steel with ultra-low temperature toughness, including the following chemical components by mass percentage: 0.05% of C. 0.17% of Si. 1.4% of Mn, 0.03% of Nb, 0.015% of Ti, 0.008% of Zr, 0.007% of RE, 0.0025% of P, 0.008% of S, 0.0025% of O, 0.0030% of N, 0.00016% of H and the balance of Fe and inevitable impurities. RE includes lanthanum and cerium, and the weight ratio of the elements lanthanum to cerium is 70:30.

This embodiment relates to a preparation method of a Ni-free micro-alloyed high-strength steel with ultra-low temperature toughness, including the following steps.

1) Molten steel is sequentially smelted and refined, then vacuum treatment is performed, and then, continuous casting is performed to obtain a slab.

The smelting and refining method is as follows: performing steel-making on molten iron, or scrap steel, or molten iron and scrap steel by using a rotary furnace or an electric are furnace, adjusting the temperature and the composition of molten steel, and adjusting the tapping temperature to 1,620° C., wherein the molten steel contains free oxygen of 250 ppm; enabling the molten steel to enter a ladle, then performing fine argon bubbling for 6 min, then, pre-deoxidizing the molten steel in the ladle by using Fe—Si alloy or Fe—Si—Mn alloy, adjusting the content of free oxygen in the molten steel to 55 ppm, and performing final deoxidation using a composite additive after fine argon bubbling for 6 min. The composite additive is added into the molten steel in the form of block alloy or a cored wire, and the particle size of the composite additive is 12 mm. The addition of the composite additive is 2.7 kg per ton of the molten steel. Then, LF refining and RH refining are performed on the molten steel according to a conventional process.

### LF Refining:

the viscosity of refining slag is controlled to be 1.517 Pa·s to 1.933 Pa·s to improve the ability of a slag system to adsorb inclusions, so as to improve the cleanliness of molten steel; the alkalinity of white slag in a refining furnace is controlled to be 5.15≤R≤7.47, which helps to increase the desulfurization rate, improve the cleanliness of the molten steel and reduce oxide inclusions in the molten steel; the MI slag index (=Cao/SiO₂:Al₂O₃) is controlled to be MI>0.147, in which a sulfur distribution coefficient is greatly increased, so that the appropriate fluidity of refining slag under a certain alkalinity is controlled; and the retention time of white slag is ≥14.46 min, the refining period is ≥39.39 min, and the soft blowing time is >4.51 min, so as to control the output [O] content.

### RH Vacuum Treatment:

the air pressure in a vacuum chamber is vacuumized to be less than 66.69 kPa, which is kept for 12.35 min to 14.47 min, and the argon bottom-blowing flow rate is 10.26 m³/h to 19.38 m³/h, so as to realize circulation of the molten steel for 4 times; the type and the weight of added alloy are strictly controlled, higher-grade low-carbon ferromanganese, metallic manganese, low-carbon ferrosilicon, ferrotitanium and other alloys are used to ensure that the composition of the molten steel is completely qualified, and ensure that the vacuum is maintained for more than 5.28 min after the alloy is added to obtain purer molten steel; and meanwhile, an appropriate temperature of the molten steel is provided for continuous casting to ensure that the degree of superheat of a tundish is 10.17° C. to 29.46° C. above the liquid phase line.

2) The slab is heated and heat-preserved for 3.5 h at 1,195° C. to obtain a heat-treated slab.

3) The heat-treated slab is continuously rolled, a final rolling temperature is controlled to be 750° C. to 850° C., cooling with water to 410° C. to 550° C. is performed after rolling, and then, naturally cooling to a room temperature is performed to obtain the micro-alloyed high-strength steel.

The rolling method is as follows: conventionally heating and soaking the slab; then continuously rolling the slab into a product steel plate, controlling the final rolling temperature to be 800° C., and cooling with water to 480° C. after rolling; and naturally cooling to room temperature for later use.

The steel plate obtained by the above process is free from a ferrite-pearlite banded structure; the effective grain size of the microstructure of the steel plate is 4.5 μm and the V-notch impact absorbing energy of the steel plate at −120° C. is greater than 315 J.

### Embodiment 2

This embodiment relates to a Ni-free micro-alloy high-strength steel with ultra-low temperature toughness, including the following chemical components by mass percentage: 0.09% of C, 0.13% of Si, 1.48% of Mn, 0.035% of Nb, 0.012% of Ti, 0.014% of Zr, 0.004% of RE, 0.0048% of P. 0.0010% of S, 0.0048% of O, 0.0038% of N, 0.00019% of H and the balance of Fe and inevitable impurities. RE includes lanthanum and cerium, and the weight ratio of the elements lanthanum to cerium is 80:20.

This embodiment relates to a preparation method of a Ni-free micro-alloyed high-strength steel with ultra-low temperature toughness, including the following steps.

1) Molten steel is sequentially smelted and refined, then vacuum treatment is performed, and then, continuous casting is performed to obtain a slab.

The smelting and refining method is as follows: performing steel-making on molten iron, or scrap steel, or molten iron and scrap steel by using a rotary furnace or an electric arc furnace, then adjusting the temperature and the composition of molten steel, and adjusting the tapping temperature to 1,680° C., wherein the molten steel contains free oxygen of 380 ppm; enabling the molten steel to enter a ladle, then performing fine argon bubbling for 8 min, then, pre-deoxidizing the molten steel in the ladle by using Fe—Si alloy or Fe—Si—Mn alloy, adjusting the content of free oxygen in the molten steel to 90 ppm, and performing final deoxidation using a composite additive after fine argon bubbling for 7 min. The composite additive is added into the molten steel in the form of block alloy or a cored wire, and the particle size of the composite additive is 19 mm. The addition of the composite additive is 4.5 kg per ton of the molten steel. Then, LF refining and RH refining are performed on the molten steel according to a conventional process.

### LF Refining:

the viscosity of refining slag is controlled to be 1.531 Pa·s to 1.964 Pa·s to improve the ability of a slag system to adsorb inclusions, so as to improve the cleanliness of molten steel; the alkalinity of white slag in a refining furnace is controlled to be 5.15≤R≤7.67, which helps to increase the desulfurization rate, improve the cleanliness of the molten steel and reduce oxide inclusions in the molten steel; the MI slag index (=Cao/SiO₂:Al₂O₃) is controlled to be MI>0.149, in which a sulfur distribution coefficient is greatly increased, so that the appropriate fluidity of refining slag under a certain alkalinity is controlled; and the retention time of white slag is ≥14.23 min, the refining period is ≥39.36 min, and the soft blowing time is >4.58 min, so as to control the output [O] content.

### RH Vacuum Treatment:

the air pressure in a vacuum chamber is vacuumized to be less than 66.59 kPa, which is kept for 12.27 min to 14.48 min, and the argon bottom-blowing flow rate is 10.21 m³/h to 19.39 m³/h, so as to realize circulation of the molten steel for 5 times; the type and the weight of added alloy are strictly controlled, higher-grade low-carbon ferromanganese, metallic manganese, low-carbon ferrosilicon, ferrotitanium and other alloys are used to ensure that the composition of the molten steel is completely qualified, and ensure that the vacuum is maintained for more than 5.33 min after the alloy is added to obtain purer molten steel; and meanwhile, an appropriate temperature of the molten steel is provided for continuous casting to ensure that the degree of superheat of a tundish is 10.17° C. to 29.49° C. above the liquid phase line.

2) The slab is heated and heat-preserved for 3.4 h at 1,205° C. to obtain a heat-treated slab.

3) The heat-treated slab is continuously rolled, a final rolling temperature is controlled to be 750° C. to 850° C., cooling with water to 410° C. to 550° C. is performed after rolling, and naturally cooling to a room temperature is performed to obtain the micro-alloyed high-strength steel.

The rolling method is as follows: conventionally heating and soaking the slab; then continuously rolling the slab into a product steel plate, controlling the final rolling temperature to be 840° C., and cooling with water to 530° C. after rolling; and naturally cooling to room temperature for later use.

The micro-alloyed high-strength steel obtained by the above process is free from a ferrite-pearlite banded structure; the effective grain size of the microstructure of the micro-alloyed high-strength steel is 4.8 μm; and the V-notch impact absorbing energy of the micro-alloyed high-strength steel at −120° C. is greater than 309 J.

### Embodiment 3

This embodiment relates to a Ni-free micro-alloy high-strength steel with ultra-low temperature toughness, including the following chemical components by mass percentage: 0.03% of C, 0.20% of Si, 1.4% of Mn, 0.035% of Nb, 0.013% of Ti, 0.010% of Zr, 0.002% of RE, 0.0020% of P. 0.0007% of S, 0.0020% of O, 0.0030% of N, 0.00016% of H and the balance of Fe and inevitable impurities. RE includes lanthanum and cerium, and the weight ratio of the elements lanthanum to cerium is 90:10.

The embodiment relates to a preparation method of a Ni-free micro-alloyed high-strength steel with ultra-low temperature toughness, including the following steps.

1) Molten steel is sequentially smelted and refined, then vacuum treatment is performed, and then, continuous casting is performed to obtain a slab.

The smelting and refining method is as follows: performing steel-making on molten iron, or scrap steel, or molten iron and scrap steel by using a rotary furnace or an electric are furnace, then adjusting the temperature and the composition of molten steel, and adjusting the tapping temperature to 1,580° C., wherein the molten steel contains free oxygen of 150 ppm; enabling the molten steel to enter a ladle, then performing fine argon bubbling for 5 min, then, pre-deoxidizing the molten steel in the ladle by using Fe—Si alloy or Fe—Si—Mn alloy, adjusting the content of free oxygen in the molten steel to 90 ppm, and performing final deoxidation using a composite additive after fine argon bubbling for 5 min. The composite additive is added into the molten steel in the form of block alloy or a cored wire, and the particle size of the composite additive is 9 mm. The addition of the composite additive is 0.59 kg per ton of the molten steel. Then, LF refining and RH refining are performed on the molten steel according to a conventional process.

### LF Refining:

the viscosity of refining slag is controlled to be 1.526 Pa·s to 1.953 Pa·s to improve the ability of a slag system to adsorb inclusions, so as to improve the cleanliness of molten steel; the alkalinity of white slag in a refining furnace is controlled to be 5.16≤R≤7.63, which helps to increase the desulfurization rate, improve the cleanliness of the molten steel and reduce oxide inclusions in the molten steel; the MI slag index (=Cao/SiO₂:Al₂O₃) is controlled to be MI>0.153, in which a sulfur distribution coefficient is greatly increased, so that the appropriate fluidity of refining slag under a certain alkalinity is controlled; and the retention time of white slag is ≥14.35 min, the refining period is ≥39.47 min, and the soft blowing time is >4.58 min, so as to control the output [O] content.

### RH Vacuum Treatment:

the air pressure in a vacuum chamber is vacuumized to be less than 66.69 kPa, which is kept for 12.21 min to 14.47 min, and the argon bottom-blowing flow rate is 10.23 m³/h to 19.46 m³/h, so as to realize circulation of the molten steel for 6 times; the type and the weight of added alloy are strictly controlled, higher-grade low-carbon ferromanganese, metallic manganese, low-carbon ferrosilicon, ferrotitanium and other alloys are used to ensure that the composition of the molten steel is completely qualified, and ensure that the vacuum is maintained for more than 5.33 min after the alloy is added to obtain purer molten steel; and meanwhile, an appropriate temperature of molten steel is provided for continuous casting to ensure that the degree of superheat of a tundish is 10.35° C. to 29.47° C. above the liquid phase line.

2) The slab is heated and heat-preserved for 3.1 h at 1225° C. to obtain a heat-treated slab.

3) The heat-treated slab is continuously rolled, a final rolling temperature is controlled to be 750° C. to 850° C., cooling with water to 410° C. to 550° C. is performed after rolling, and naturally cooling to a room temperature is performed to obtain the micro-alloyed high-strength steel.

The rolling method is as follows: conventionally heating and soaking the slab; then continuously rolling the slab into a product steel plate, controlling the final rolling temperature to be 760° C., and cooling with water to 430° C. after rolling; and naturally cooling to room temperature for later use.

The micro-alloyed high-strength steel obtained by the above process is free from a ferrite-pearlite banded structure; the effective grain size of the microstructure of the micro-alloyed high-strength steel is 4.4 μm; and the V-notch impact absorbing energy of the micro-alloyed high-strength steel at −120° C. is greater than 311 J.

### Experimental Example

A series of low-temperature impact properties are tested and analyzed with reference to the Ni-free micro-alloyed high-strength steel (also known as R&D steel) with ultra-low temperature toughness prepared in Embodiment 1 to obtain the following results.

### (1) Method for Testing Low-Temperature Impact Performance

The low-temperature impact test shall be carried out according to the national standards GB/T229-2020 Metallic Materials-Charpy Pendulum Impact Test Method and GB/T19748-2019 Metallic Materials-Charpy V-notch Pendulum Impact Test-Instrumented Test Method. The sample is a 55×10×10 mm standard sample, with a V-notch, the notch having a depth of 2 mm and a root radius of 0.25 mm. A striking edge of the pendulum has a radius of curvature of 2 mm. Test temperatures include 20° C., −20° C., −40° C., −60° C., −80° C., −100° C., −110° C., −120° C., −130° C., −140° C., −160° C. and −196° C. During pendulum impact, the values of force and displacement are recorded by a resistance strain gauge on the striking edge and an optical method respectively, so that a force-displacement curve in the impact process is acquired, and the impact absorbing energy is acquired by means of integral calculation.

### (2) Result Analysis of Low-Temperature Impact Toughness

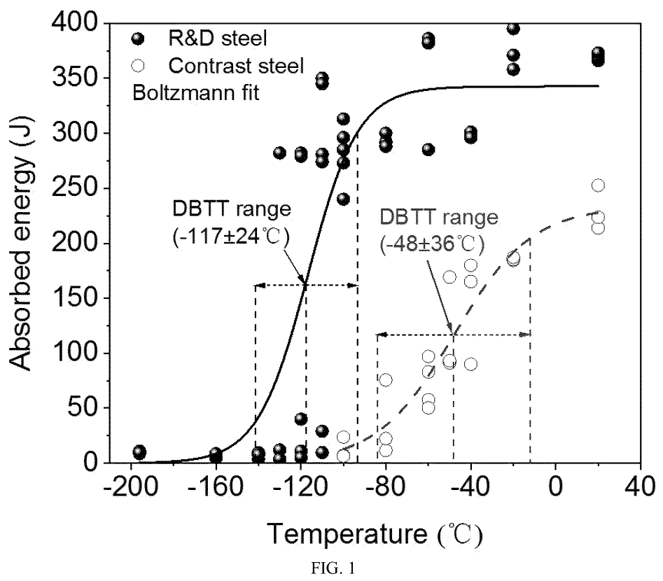

FIG. 1 is a low-temperature ductile-brittle transition temperature (DBTT) curve of the micro-alloyed high-strength steel according to the present invention. As shown in FIG. 1, the ductile-brittle transition temperature of the micro-alloyed high-strength steel according to the present invention approximately ranges from about −110° C. to −130° C., which is lower than the standard requirement of the same strength FH36 (the standard requirement is that the ductile-brittle transition temperature is lower than −60° C.) by more than 50° C.

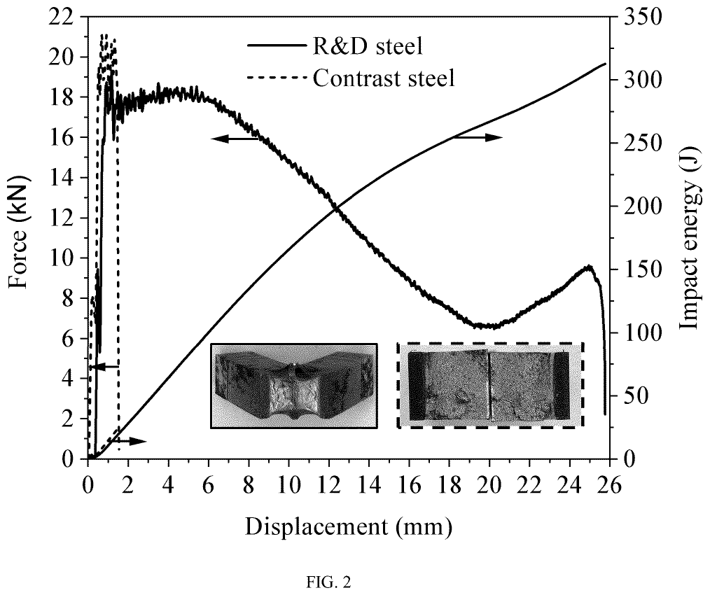

FIG. 2 is a comparison of −100° C. oscillographic impact curves between the micro-alloyed high-strength steel according to the present invention and contrast steel of the same type. The micro-alloyed high-strength steel according to the present invention has a complete crack initiation-propagation-passivation process in a −100° C. impact process, while the contrast steel declines rapidly after yield of the force-displacement curve, indicating that the contrast steel is subject to an instantaneous brittle fracture upon crack initiation without a process of stable crack propagation and passivation.

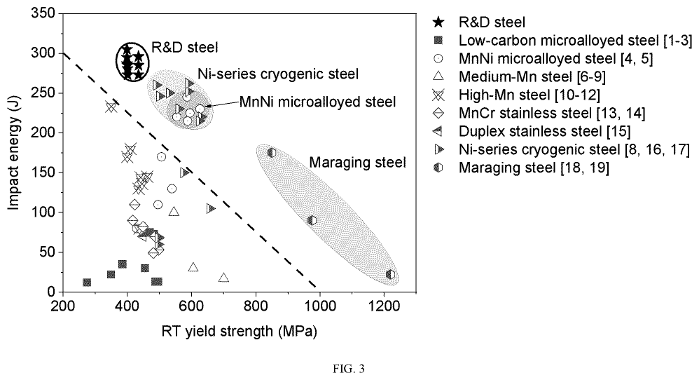

FIG. 3 is an Ashby diagram of impact energy at −100° C. to yield strength at room temperature of the micro-alloyed high-strength steel according to the present invention and contrast steel, in which the dotted line is a connecting line between coordinates (200 MPa, 300 J) and coordinates (1,000 MPa, 0 J). It is believed that the type of steel on the right side of the dotted line achieves an excellent trade-off between low-temperature impact toughness and room-temperature yield strength. It can be known from FIG. 3 that the micro-alloyed high-strength steel according to the present invention has the highest impact energy at −100° C., which is higher than that of traditional low-carbon micro-alloyed steel^{[1-3]}, medium manganese steel^{[6-9]}, chromium-manganese stainless steel^{[13-14]}, duplex stainless steel^{[15]}, nickel-based low-temperature steel^{[8,16,17]}, maraging steel^{[18,19]}, manganese-nickel micro-alloyed steel^{[4,5]} and high manganese steel^{[10-12]}.

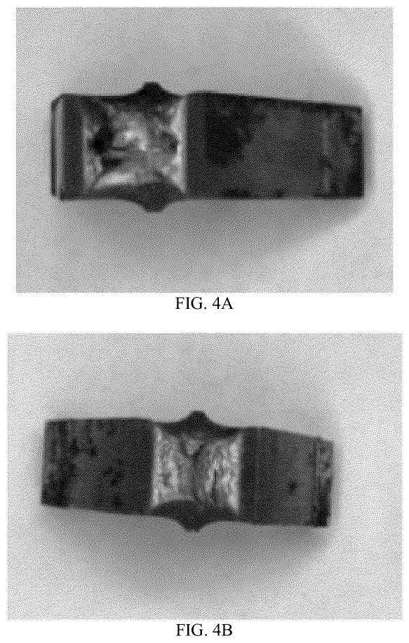

FIGS. 4A-4B show macro-morphology of impact fractures of the micro-alloyed high-strength steel according to the present invention at two low temperatures −100° C. and −120° C. It can be seen from FIG. 4A that at −100° C., the micro-alloyed high-strength steel according to the present invention is completely subject to a ductile fracture; and the micro-alloyed high-strength steel according to the present invention is completely transformed into a brittle fracture at −120° C. in FIG. 4B.

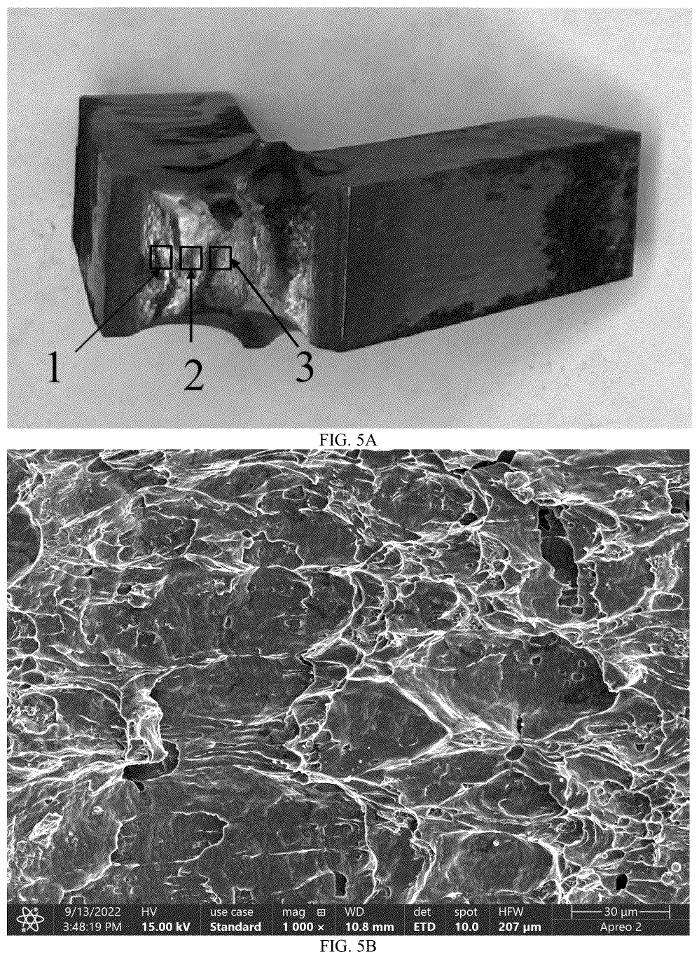

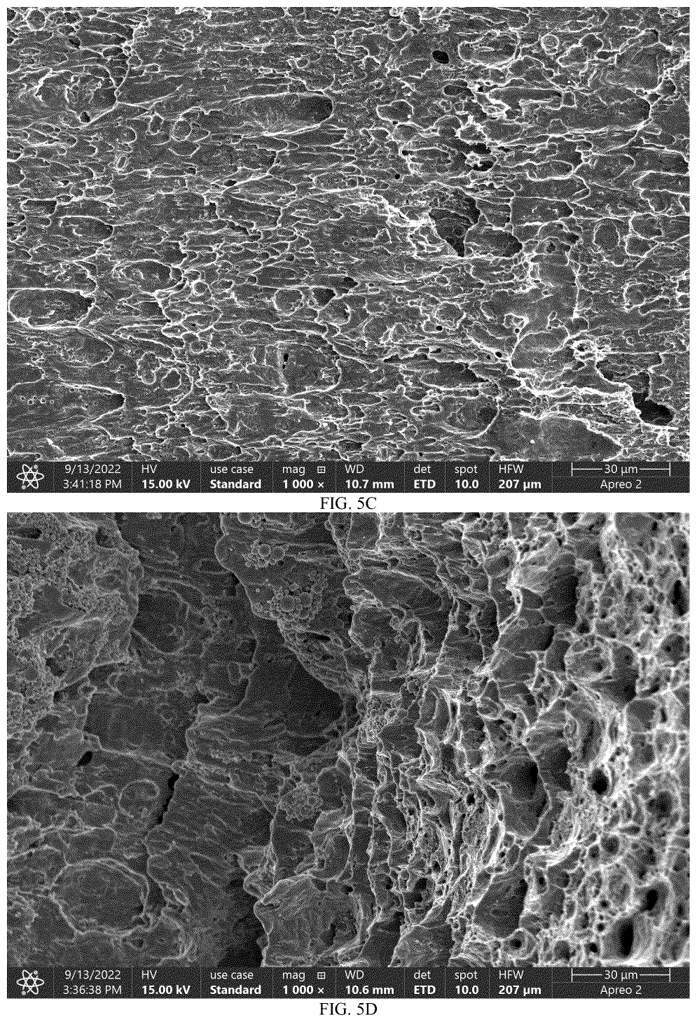

FIG. 5A shows a Charpy impact fracture at −100° C. of the micro-alloyed high-strength steel according to the present invention. FIGS. 5B-5D are micro-morphologies of parts 1-3 in FIG. 5A, respectively. It is thus clear that both of the fracture initiation and the stable crack propagation are manifested as dimple morphology stretched in the direction of the fracture, and there are a lot of tear marks at the edge of the dimple, and the crack passivation is manifested as a mixed morphology of a diagonal dimple and a normal dimple.

The requirements on the properties of low-temperature steel lie in that first of all, sufficient impact toughness at the service temperature should be ensured, and from the point of view of fracture mechanics, the material should have sufficient brittle cracking resistance at the service temperature. On special important structures, in order to avoid accidents, the material should have the crack arrest property against brittle crack propagation. In addition, from the safety point of view, it is expected that the yield ratio of the low temperature steel should not be high. The greater the yield ratio is, the lower the reserve of plastic deformation capacity is, and the lower the stress redistribution capacity at the stress concentration part is, so that it is prone to have brittle fracture.

The technical requirements on low-temperature steel are generally as follows: sufficient strength and adequate toughness at low temperature, and excellent technological properties, processability and corrosion resistance. Low-temperature toughness, i.e., the ability to avoid occurrence and propagation of brittle fracture at low temperature, is the most important factor. Therefore, a certain value of impact toughness at the lowest temperature is usually stipulated in all countries.

At present, in order to meet the above requirement of low-temperature toughness, the conventional technology is to use nickel for alloying. This is mainly because: (1) Ni does not form a carbide with carbon, but is a main alloying element for forming and stabilizing austenite; (2) Ni is a pure soluble element in steel, which can strengthen the ferrite matrix and obviously reduce the ductile-brittle transition temperature; (3) a fine grain structure is acquired by means of controlled rolling; and (4) a stable structure is acquired by means of heat treatment.

However, in the present invention, a completely different composition design (i.e., a simple low-cost Ni-free composition design) and a matched manufacturing process are used to realize ultra-low temperature toughness, and with the help of Zr+RE compound deoxidation and Nb+Ti compound micro-alloying technologies, ultra-low temperature toughness at −100° C. to −120° C. is realized. The micro-alloyed high-strength steel plate according to the present invention uses a cheap chemical composition design of low carbon, low silicon and medium manganese, and is completely free from precious metal elements such as Cr, Ni and Cu, thereby greatly reducing the material cost. Instead of the traditional Al deoxidation technology, the present invention uses Si—Mn deoxidation supplemented with Zr—Ti-RE compound deoxidation to form a fine, dispersed and uniform composite oxysulfide, which significantly improves the plasticity and toughness. By means a low-carbon equivalent design, the micro-alloyed high-strength steel plate according to the present invention has excellent welding performance. By using Nb, Ti. Zr and RE compound micro-alloying, together with rolling parameter control in the TMCP, the steel plate has fine grains, and high strength and toughness. Such a Ni-free micro-alloyed high-strength low-temperature steel is particularly suitable for structural materials of polar regions, vessels, pipelines, refining, storage and transportation, devices and the like used in low-temperature and ultra-low temperature (−20 to −120° C.) environments. In addition to its excellent low-temperature toughness and its superiority, this material also has significant characteristics such as high strength and excellent weldability.

Reference documents [1]-[19] for low-carbon micro-alloyed steel^{[1-3]}, medium manganese steel^{[6-9]}, chromium-manganese stainless steel^{[13-14]}, duplex stainless steel^{[15]}, nickel-based low-temperature steel^{[8,16,17]}, maraging steel^{[18,19]}, manganese-nickel micro-alloyed steel^{[4,5]} and high manganese steel^{[10-12]} are listed as below:
[1] H. Tervo, A. Kaijalainen, S. Pallaspuro, S. Anttila, S. Mehtonen, D. Porter, J. Kömi. Low-temperature toughness properties of 500 MPa offshore steels and their simulated coarse-grained heat-affected zones. Materials Science and Engineering: A, 2020, 773: 138719.
[2] X. Chen, A. Guo, H. Dong, S. Li. The properties of high toughness low-temperature −70° C. steel 09MnNiDR. International Journal of Pressure Vessels and Piping, 1999, 76(1): 13-17.
[3] Y. J. Chao, J. D. Ward, Jr. R. G. Sands. Charpy impact energy, fracture toughness and ductile-brittle transition temperature of dual-phase 590 Steel. Materials & Design, 2007, 28(2): 551-557.
[4] L. Jiang, J. Wang, T. Zhang, T. Dorin, X. Sun. Superior low temperature toughness in a newly designed low Mn and low Ni high strength steel. Materials Science and Engineering: A, 2021, 85: 141899.
[5] J. Chen, W. Zhang, Z. Liu, G. Wang. The role of retained austenite on the mechanical properties of a low carbon 3Mn-1.5Ni Steel. Metallurgical and Materials Transactions A, 2017, 48: 5849-5859.
[6] G. Su, X. Gao, D. Zhang, L. Du, J. Hu, Z. Liu. Impact of reversed austenite on the impact toughness of the high˜strength steel of low carbon medium manganese. JOM, 2018, 70:672-679.
[7] H. Liu, L. X. Du, J. Hu, H. Y. Wu, X. H. Gao, R. D. K. Misra. Interplay between reversed austenite and plastic deformation in a directly quenched and intercritically annealed 0.04C-5Mn low-Al steel. Journal of Alloys and Compounds, 2017, 695:2072-2082.
[8] H. W. Lee, T. M. Park, N. Seo, S. J. Lee, C. Lee, J. Han. Design of low-Ni martensitic steels with novel cryogenic impact toughness exceeding 190 J. Materials Science and Engineering: A, 2022, 840: 142959.
[9] I. C. Yi, Y. Ha, H. Lee, A. Zargaran, N.J. Kim. Improvement of impact toughness of 5Mn-1Al-0.5Ti steel by intercritical annealing. Metals and Materials International, 2017, 23:283-289.
[10] J. Lee, S. S. Sohn, S. Hong, B. C. Suh, S. K. Kim, B. J. Lee, N.J. Kim, S. Lee. Effects of Mn addition on tensile and charpy impact properties in austenitic Fe—Mn—C—Al-based steels for cryogenic applications. Metallurgical and Materials Transactions A, 2014, 45:5419-5430.
[11] S. S Sohn, S. Hong, J. Lee, B. C. Suh, S. K. Kim, B. J. Lee, N.J. Kim, S. Lee. Effects of Mn and Al contents on cryogenic-temperature tensile and Charpy impact properties in four austenitic high-Mn steels. Acta Materialia, 2015, 100:39-52.
[12] Q. Luo, H. H. Wang, G. Q. Li, C. Sun, D. H. Li, X. L. Wan. On mechanical properties of novel high-Mn cryogenic steel in terms of SFE and microstructural evolution. Materials Science and Engineering: A, 2019, 753:91-98.
[13] M. Milititsky, D. K. Matlock, A. Regully, N. Dewispelaere, J. Penning, H. Hanninen. Impact toughness properties of nickel-free austenitic stainless steels. Materials Science and Engineering: A, 2008, 496(1-2): 189-199.
[14] Y. Tomota, Y. Xia, K. Inoue. Mechanism of low temperature brittle fracture in high nitrogen bearing austenitic steels. Acta Materialia, 1998, 46(5): 1577-1587.
[15] C. Gennari, L. Pezzato, E. Piva, R. Gobbo, I. Calliari. Influence of small amount and different morphology of secondary phases on impact toughness of UNS S32205 Duplex Stainless Steel. Materials Science and Engineering: A, 2018, 729: 14-156.
[16] M. Wang, Z. Y. Liu, C. G. Li. Correlations of Ni contents, formation of reversed austenite and toughness for Ni-containing cryogenic steels. Acta Metallurgica Sinica (English Letters), 2017, 30: 238-249.
[17] J. Chen, Z. Liu. The combination of strength and cryogenic impact toughness in low carbon 5Mn-5Ni steel. Journal of Alloys and Compounds, 2020, 837: 155484.
[18] U. K. Viswanathan, R. Kishore, M. K. Asundi. Effect of thermal cycling on the mechanical properties of 350-grade maraging steel. Metallurgical and Materials Transactions A, 1996, 27: 757-761.
[19] H. Zhang, M. Sun, Y. Liu, D. Ma, B. Xu, M. Huang, D. Li, Y. Li. Ultrafine-grained dual-phase maraging steel with high strength and excellent cryogenic toughness. Acta Materialia, 2021, 211: 116878.

In the descriptions of the present description, the descriptions of referring terms such as “one embodiment”, “some embodiments”, “examples”, “specific examples” or “some examples” refer to specific features, structures, materials or characteristics described in combination with the embodiment or example are included in at least one embodiment or example of the present invention. In the description, the schematic representation of the terms described above does not necessarily refer to the same embodiment or example. Furthermore, the described particular features, structures, materials, or characteristics may be combined in any suitable manner in any one or more embodiments or examples. In addition, different embodiments or examples described in the present description, as well as features of different embodiments or examples, may be integrated and combined without contradicting each other.

Although the embodiments of the present invention are illustrated and described as above, it can be understood that these embodiments are exemplary and cannot be construed as limitations to the present invention. Those of ordinary skills in the art can make possible changes, modifications, substitutions and variations to the embodiments described as above within the scope of the present invention.

What is claimed is:

1. A Ni-free micro-alloyed high-strength steel with an ultra-low temperature toughness, comprising the following chemical components by a mass percentage: 0.011% to 0.099% of C, 0.051% to 0.24% of Si, 1.21% to 1.49% of Mn, 0.030% to 0.059% of Nb, 0.009% to 0.016% of Ti, 0.001% to 0.018% of Zr, 0.001% to 0.018% of rare earth RE, and a balance of Fe and inevitable impurities, wherein
the mass percentage of the C and the mass percentage of the Si meet a formula: 0.21%<C+Si<0.24%, and Si/C=1 to 8;
the mass percentage of the Nb and the mass percentage of the Ti meet a formula: 0.02%<Nb+Ti<0.05%, and Nb/Ti=1 to 3; and
the mass percentage of the Zr and the mass percentage of the rare earth RE meet a formula: 0.010%<Zr+RE<0.019%, and Zr/RE=1 to 6.

2. The Ni-free micro-alloyed high-strength steel with the ultra-low temperature toughness according to claim 1, comprising the following chemical components by the mass percentage: 0.03% to 0.09% of the C, 0.13% to 0.20% of the Si, 1.4% to 1.48% of the Mn, 0.035% to 0.055% of the Nb, 0.009% to 0.016% of the Ti, 0.010% to 0.015% of the Zr, 0.002% to 0.004% of the rare earth RE, and the balance of the Fe and the inevitable impurities.

3. The Ni-free micro-alloyed high-strength steel with the ultra-low temperature toughness according to claim 1, comprising the following chemical components by the mass percentage: 0.05% of the C, 0.17% of the Si, 1.4% of the Mn, 0.03% of the Nb, 0.015% of the Ti, 0.008% of the Zr, 0.007% of the rare earth RE, and the balance of the Fe and the inevitable impurities.

4. The Ni-free micro-alloyed high-strength steel with the ultra-low temperature toughness according to claim 1, wherein the inevitable impurities comprise elements P, S, O, N, and H, mass percentages of the elements P, S, O, N, and H respectively meet: P≤0.0049%, S≤0.0010%, O≤0.0049%, N≤0.0039%, and H≤0.00019.

5. The Ni-free micro-alloyed high-strength steel with the ultra-low temperature toughness according to claim 1, wherein the rare earth RE comprises lanthanum and cerium, and a weight ratio of the lanthanum to the cerium is (70-90):(10-30).

6. The Ni-free micro-alloyed high-strength steel with the ultra-low temperature toughness according to claim 1, wherein a type of a microstructure of the Ni-free micro-alloyed high-strength steel is free from a ferrite-pearlite banded structure, and an effective grain size of the microstructure of the Ni-free micro-alloyed high-strength steel is less than or equal to 5 μm.

7. The Ni-free micro-alloyed high-strength steel with the ultra-low temperature toughness according to claim 1, wherein the Ni-free micro-alloyed high-strength steel has a V-notch impact absorbing energy of greater than 300 J at −120° C.

8. The Ni-free micro-alloyed high-strength steel with the ultra-low temperature toughness according to claim 1, wherein the Ni-free micro-alloyed high-strength steel has a ductile-brittle transition temperature of −110° C. to −130° C.

9. A preparation method of the Ni-free micro-alloyed high-strength steel with the ultra-low temperature toughness according to claim 1, comprising the following steps:
1) sequentially smelting and refining a molten steel to obtain a resulting steel, then performing a vacuum treatment on the resulting steel to obtain a treated steel, and then performing a continuous casting on the treated steel to obtain a slab;
2) heating and soaking the slab to obtain a heat-treated slab; and
3) continuously rolling the heat-treated slab to obtain a rolled slab, controlling a final rolling temperature to be 750° C. to 850° C., cooling the rolled slab with water to 410° C. to 550° C. after the rolling to obtain a water-cooled slab, and then naturally cooling the water-cooled slab to a room temperature to obtain the Ni-free micro-alloyed high-strength steel.

10. The preparation method of the Ni-free micro-alloyed high-strength steel with the ultra-low temperature toughness according to claim 9, wherein a method of sequentially smelting and refining in step 1) is as follows: performing steel-making on a molten iron and/or a scrap steel by using a rotary furnace or an electric arc furnace to obtain a resulting product, then adjusting a temperature and a composition of the resulting product to obtain a molten steel, and adjusting a tapping temperature of the molten steel to 1,549° C. to 1,689° C., wherein the molten steel contains free oxygen of 99 ppm to 398 ppm; enabling the molten steel to enter a ladle, and pre-deoxidizing the molten steel in the ladle by using a Fe—Si alloy or a Fe—Si—Mn alloy under a fine argon bubbling to adjust a content of the free oxygen in the molten steel to 10 ppm to 98 ppm; and performing a final deoxidation using a composite additive under the fine argon bubbling, and performing an LF refining, a VD refining, or a RH refining on the molten steel subjected to the final deoxidation.

11. The Ni-free micro-alloyed high-strength steel with the ultra-low temperature toughness according to claim 2, wherein the inevitable impurities comprise elements P, S, O, N, and H, mass percentages of the elements P, S, O, N, and H respectively meet: P≤0.0049%, S≤0.0010%, O≤0.0049%, N≤0.0039%, and H≤0.00019.

12. The Ni-free micro-alloyed high-strength steel with the ultra-low temperature toughness according to claim 3, wherein the inevitable impurities comprise elements P, S, O, N, and H, mass percentages of the elements P, S, O, N, and H respectively meet: P≤0.0049%, S≤0.0010%, O≤0.0049%, N≤0.0039%, and H≤0.00019.

13. The Ni-free micro-alloyed high-strength steel with the ultra-low temperature toughness according to claim 2, wherein the rare earth RE comprises lanthanum and cerium, and a weight ratio of the lanthanum to the cerium is (70-90):(10-30).

14. The Ni-free micro-alloyed high-strength steel with the ultra-low temperature toughness according to claim 3, wherein the rare earth RE comprises lanthanum and cerium, and a weight ratio of the lanthanum to the cerium is (70-90):(10-30).

15. The Ni-free micro-alloyed high-strength steel with the ultra-low temperature toughness according to claim 2, wherein a type of a microstructure of the Ni-free micro-alloyed high-strength steel is free from a ferrite-pearlite banded structure, and an effective grain size of the microstructure of the Ni-free micro-alloyed high-strength steel is less than or equal to 5 μm.

16. The Ni-free micro-alloyed high-strength steel with the ultra-low temperature toughness according to claim 3, wherein a type of a microstructure of the Ni-free micro-alloyed high-strength steel is free from a ferrite-pearlite banded structure, and an effective grain size of the microstructure of the Ni-free micro-alloyed high-strength steel is less than or equal to 5 μm.

17. The Ni-free micro-alloyed high-strength steel with the ultra-low temperature toughness according to claim 2, wherein the Ni-free micro-alloyed high-strength steel has a V-notch impact absorbing energy of greater than 300 J at −120° C.

18. The Ni-free micro-alloyed high-strength steel with the ultra-low temperature toughness according to claim 3, wherein the Ni-free micro-alloyed high-strength steel has a V-notch impact absorbing energy of greater than 300 J at −120° C.

19. The Ni-free micro-alloyed high-strength steel with the ultra-low temperature toughness according to claim 2, wherein the Ni-free micro-alloyed high-strength steel has a ductile-brittle transition temperature of −110° C. to −130° C.

20. The Ni-free micro-alloyed high-strength steel with the ultra-low temperature toughness according to claim 3, wherein the Ni-free micro-alloyed high-strength steel has a ductile-brittle transition temperature of −110° C. to −130° C.
